(19) United States
(12) Patent Application Publication
(10) Pub. No.: US 2026/0131777 A1
(43) Pub. Date: May 14, 2026

(54) AUTOMOBILE, BRAKE SYSTEM, BRAKE, AND BRAKE STATE MONITORING METHOD

(71) Applicant: NEXTEER AUTOMOTIVE (SUZHOU) CO., LTD., Suzhou (CN)

(72) Inventors: Dongsheng (Buck) ZHANG, Suzhou (CN); Zhenfei (Peter) HU, Suzhou (CN); Yan (Nemo) LV, Suzhou (CN)

(21) Appl. No.: 19/385,277

(22) Filed: Nov. 11, 2025

(30) Foreign Application Priority Data
Nov. 11, 2024 (CN) 2024116029925

(51) Int. Cl. B60T 13/74; B60T 17/22

(52) U.S. Cl. CPC B60T 13/746; B60T 17/22

(57) ABSTRACT

A power-off brake system includes: a brake motor shaft; a stator coaxially disposed around the brake motor shaft; a flange rotor connected to the brake motor shaft and to the stator via a rolling bearing, such that a flange rotor rotates with the brake motor shaft relative to the stator; an armature connected to the flange rotor; and a coil that: (i) in a de-energized state, causes the armature to engage a grooved disc, locking the brake motor shaft; and (ii) in an energized state, causes the armature to disengage the grooved disc, releasing the brake motor shaft.

### CROSS REFERENCE TO RELATED APPLICATIONS

This U.S. Non-Provisional Patent Application claims priority to Chinese Patent Application Serial No. 2024116029925 filed November 11, 2024, the contents of which are incorporated herein by reference in its entirety.

### TECHNICAL FIELD

The present invention relates to the field of automobile manufacturing, and in particular, to an automobile, a brake system, a brake, and a brake state monitoring method.

### BACKGROUND ART

With the rapid development of the automobile industry and related technical fields, electromechanical brake systems have become a research hotspot for major automobile companies and scientific research institutions.

Most electromechanical brake systems use ratchet-pawl structures or electromagnetic brakes to lock the brake mechanisms, thereby realizing auxiliary braking and improving braking safety.

However, existing ratchet-pawl structures and conventional electromagnetic brakes both have great limitations. Ratchet-pawl structures have the problems of large volume, large energy loss and high noise, and conventional electromagnetic brakes have the problems of high manufacturing difficulty and inconvenient state testing, which limits the development of electromechanical brake systems.

### SUMMARY OF THE INVENTION

The present invention provides an automobile, a brake system, a brake, and a brake state monitoring method, so as to reduce volume, noise, and energy loss, and lower manufacturing and testing difficulty.

According to an aspect of the present invention, there is provided a power-off brake applied to a brake motor of an electromechanical brake system;

The power-off brake comprises a stator and a flange rotor coaxially stacked and sleeved around a rotating shaft of the brake motor, as well as a rolling bearing, a grooved disc, an armature, an elastic member, a permanent magnet and a coil.

A side of the stator distant from the flange rotor is connected to an end cover of the brake motor; the flange rotor is connected to the rotating shaft of the brake motor and also connected to the stator through the rolling bearing, so that the flange rotor can rotate relative to the stator along with the rotating shaft of the brake motor.

The grooved disc is disposed on a side of the stator close to the stator; the armature is disposed between the grooved disc and the flange rotor, and is connected to the flange rotor through the elastic member, so that the armature can reciprocate between the flange rotor and the grooved disc along an axial direction of the flange rotor, and a shape of a groove on the grooved disc fits with a shape of the armature directly facing the groove.

The permanent magnet is disposed on the stator, the permanent magnet generating a first magnetic force on the armature, the first magnetic force being opposite in direction to a restoring tensile force of the elastic member on the armature, and the first magnetic force being greater than the restoring tensile force of the elastic member on the armature; when the coil is de-energized, the first magnetic force resists the restoring tensile force, so that the armature moves toward the grooved disc and correspondingly engages with the grooved disc, so as to lock the rotating shaft of the brake motor.

The coil is disposed on the stator, the coil generating a second magnetic force on the armature after being energized, the second magnetic force being opposite in direction to the first magnetic force, and a resultant force of the second magnetic force and the restoring tensile force being greater than the first magnetic force; when the coil is energized, the resultant force of the second magnetic force and the restoring tensile force resists the first magnetic force, so that the armature moves toward the flange rotor and disengages from the grooved disc, so as to release the rotating shaft of the brake motor.

Optionally, the power-off brake further comprises a micro switch.

The micro switch is disposed on the stator, the micro switch being triggered to turn on when the armature is engaged with the grooved disc, and returning to an off state when the armature is disengaged from the grooved disc.

Optionally, the micro switch comprises two micro spring blades, a state detection member and an output terminal, root portions of the two micro spring blades and the output terminal being separately connected to the state detection member, and end portions of the micro spring blades extending beyond the grooved disc in a first direction, so that the two micro spring blades are disconnected when the armature is disengaged from the grooved disc, and the two micro spring blades are connected through the armature when the armature is engaged with the grooved disc.

The state detection member is used to: generate and output a disengaged state signal to the outside through the output terminal when the two micro spring blade are disconnected; and generate and output an engaged state signal to the outside through the output terminal when the two micro spring blade are connected.

Optionally, the elastic member comprises a disc spring or a leaf spring.

According to another aspect of the present invention, there is provided an electromechanical brake system, the electromechanical brake system comprising a brake disc, a brake caliper, a gearbox, a brake motor and the power-off brake according to any one of claims 1 to 4, wherein the power-off brake and the brake motor are integrated into a motor assembly.

Optionally, the motor assembly further comprises a protective ring.

One end of the protective ring is sleeved and mounted on a side surface of an end cover of the brake motor, and forms an annular groove with an outer surface of the end cover and the rotating shaft of the brake motor.

The power-off brake is disposed in the annular groove, the stator of the power-off brake is connected to the end cover through a bolt, and the flange rotor of the power-off brake is connected to the rotating shaft through a toothed spline.

Optionally, the motor assembly further comprises a first thermal insulation damping washer and a second thermal insulation damping washer.

The first thermal insulation damping washer is disposed between the stator and the end cover, and is used to reduce heat propagation and vibration propagation between the stator and the end cover.

The second thermal insulation damping washer is disposed between an end face of the protective ring and the gearbox, and is used to reduce heat propagation and vibration propagation between the power-off brake and the gearbox.

According to another aspect of the present invention, there is provided an automobile comprising the electromechanical brake system described in any of the previous aspects.

According to yet another aspect of the present invention, there is provided a state monitoring method for a power-off controller, the state monitoring method for the power-off controller comprising: when a coil is energized, monitoring a real-time current in the coil; when the real-time current in the coil has a sudden rising inflection point, determining that an armature of the power-off controller is disengaged; and when the real-time current in the coil has a sudden falling inflection point, determining that the armature of the power-off controller is engaged.

Optionally, while monitoring the real-time current in the coil, the state monitoring method further comprises: monitoring an on/off state of a micro switch; when the micro switch is turned off, determining that the armature of the power-off controller is disengaged; and when the micro switch is turned on, determining that the armature of the power-off controller is engaged.

In the technical solution of an embodiment of the present invention, the power-off brake is provided with a stator, a flange rotor, a rolling bearing, a grooved disc, an armature, an elastic member, a permanent magnet and a coil; a side of the stator distant from the flange rotor is connected to an end cover of the brake motor; the flange rotor is connected to the rotating shaft of the brake motor, and also connected to the stator through the rolling bearing, so that the flange rotor can rotate relative to the stator along with the rotating shaft of the brake motor. The grooved disc is disposed on a side of the stator close to the flange rotor; the armature is disposed between the grooved disc and the flange rotor, and is connected to the flange rotor through the elastic member, so that the armature can reciprocate between the flange rotor and the grooved disc along an axial direction of the flange rotor, and a shape of a groove on the grooved disc fits with a shape of the armature directly facing the groove. The permanent magnet is disposed on the stator, the permanent magnet generating a first magnetic force on the armature, the first magnetic force being opposite in direction to a restoring tensile force of the elastic member on the armature, and the first magnetic force being greater than the restoring tensile force of the elastic member on the armature; when the coil is de-energized, the first magnetic force resists the restoring tensile force, so that the armature moves toward the grooved disc and correspondingly engages with the grooved disc, so as to lock the rotating shaft of the brake motor. The coil is disposed on the stator, the coil generating a second magnetic force on the armature after being energized, the second magnetic force being opposite in direction to the first magnetic force, and a resultant force of the second magnetic force and the restoring tensile force being greater than the first magnetic force; when the coil is energized, the resultant force of the second magnetic force and the restoring tensile force resists the first magnetic force, so that the armature moves toward the flange rotor and disengages from the grooved disc, so as to release the rotating shaft of the brake motor, thereby realizing locking and releasing of the corresponding brake motor. The brake is integrated on the motor, which reduces volume, noise and energy loss compared with the prior art, and the structure is simple, which lowers manufacturing and testing difficulty.

It should be understood that the content described in this section is not intended to identify key or important features of the embodiments of the present invention, nor is it intended to limit the scope of the present invention. Other features of the present invention will become readily apparent from the following description.

### BRIEF DESCRIPTION OF THE DRAWINGS

To more clearly illustrate the technical solutions in the embodiments of the present invention, a brief introduction of the drawings required for use in the description of the embodiments will be given below. It is obvious that the drawings described below are only some embodiments of the present invention. For those of ordinary skill in the art, other drawings can be obtained according to these drawings without any inventive effort.

FIG. 1 is a schematic structural diagram of a power-off brake provided by an embodiment of the present invention;

FIG. 2 is a schematic diagram showing the three-dimensional structure of a power-off brake provided by an embodiment of the present invention;

FIG. 3 is a schematic structural diagram of a micro switch provided by an embodiment of the present invention;

FIG. 4 is a schematic diagram showing the principle of a micro switch provided by an embodiment of the present invention when it is turned on and off;

FIG. 5 is a schematic diagram of the composition of an electromechanical brake system provided by an embodiment of the present invention;

FIG. 6 is a schematic diagram of the composition of a motor assembly provided by an embodiment of the present invention;

FIG. 7 is a schematic diagram of the composition of an automobile provided by an embodiment of the present invention;

FIG. 8 is a schematic flowchart of a state monitoring method for a power-off brake provided by an embodiment of the present invention;

FIG. 9 is a schematic flowchart of a stepwise determination method for an armature disengagement process provided by an embodiment of the present invention;

FIG. 10 is a curve of changes of a coil voltage and a coil current before and after the armature disengagement of a power-off controller provided by an embodiment of the present invention; and

FIG. 11 is a schematic flowchart of another state monitoring method for a power-off brake provided by an embodiment of the present invention.

### DETAILED DESCRIPTION OF THE EMBODIMENTS

To enable those skilled in the art to better understand the solutions of the present invention, the technical solutions in embodiments of the present invention will be clearly and completely described below in conjunction with the drawings in the embodiments of the present invention. It is obvious that the described embodiments are only a portion of the embodiments of the present invention, rather than all of the embodiments. On the basis of the embodiments of the present invention, all other embodiments obtained by those of ordinary skill in the art without any inventive effort shall fall within the scope of protection of the present invention.

It should be noted that the terms “first”, “second” and the like in the description, claims and drawings of the present invention are used to distinguish similar objects, and are not necessarily used to describe a particular order or sequence. It should be understood that the data used in this way may be interchanged under appropriate circumstances, so that the embodiments of the present invention described herein can be implemented in an order other than those illustrated or described herein. In addition, the terms “include”, “have” and any other variations are intended to cover non-exclusive inclusion. For example, a process, method, system, product, or device that includes a list of steps or units is not necessarily limited to those steps or units expressly listed, but may include other steps or units not expressly listed or inherent to such a process, method, product, or device.

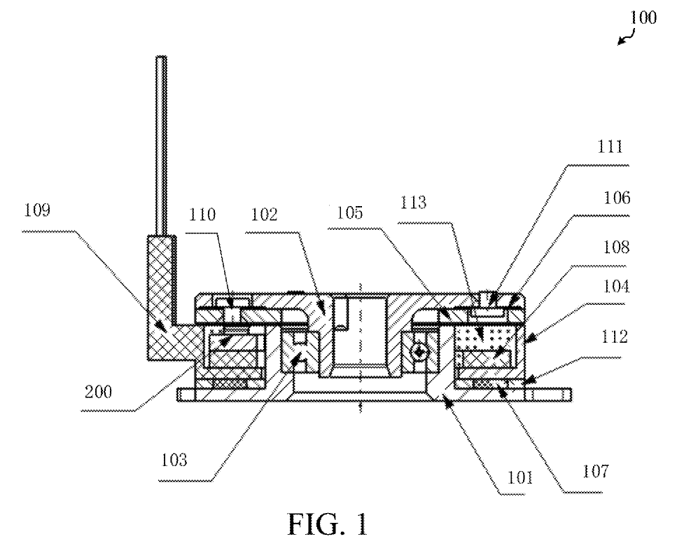

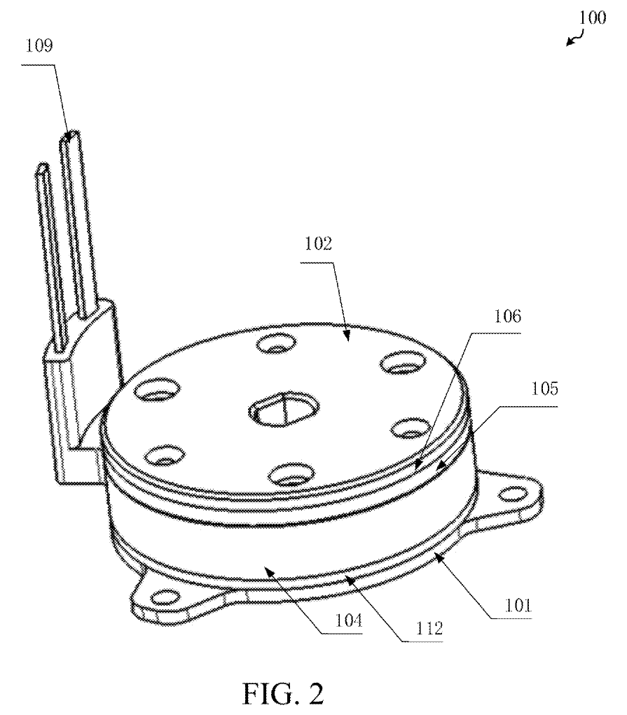

To solve the problems mentioned in the Background Art, the embodiments of the present invention provide a power-off brake, which is applied to an electromechanical brake system to lock or release a rotating shaft of a brake motor as needed, thereby realizing stable parking of the electromechanical brake system. FIG. 1 is a schematic structural diagram of a power-off brake provided by an embodiment of the present invention, and FIG. 2 is a schematic diagram showing the three-dimensional structure of a power-off brake provided by an embodiment of the present invention. With reference to FIGS. 1 and 2, the power-off brake 100 comprises a stator 101 and a flange rotor 102 coaxially stacked and sleeved around a rotating shaft of a brake motor, as well as a rolling bearing 103, a grooved disc 104, an armature 105, an elastic member 106, a permanent magnet 107, and a coil 108. A side of the stator 101 distant from the flange rotor 102 is connected to an end cover of the brake motor; and the flange rotor 102 is connected to the rotating shaft of the brake motor, and also connected to the stator 101 through the rolling bearing 103, so that the flange rotor 102 can rotate relative to the stator 101 with the rotating shaft of the brake motor. The grooved disc 104 is disposed on a side of the stator 101 close to the flange rotor 102; the armature 105 is disposed between the grooved disc 104 and the flange rotor 102 and connected to the flange rotor 102 through the elastic member 106, so that the armature 105 can reciprocate between the flange rotor 102 and the grooved disc 104 along an axial direction of the flange rotor 102; and the shape of a groove on the grooved disc 104 fits with the shape of the armature 105 directly facing the groove. The permanent magnet 107 is disposed on the stator 101, the permanent magnet 107 generating a first magnetic force on the armature 105, the first magnetic force being opposite in direction to a restoring tensile force of the elastic member 106 on the armature 105, and the first magnetic force being greater than the restoring tensile force of the elastic member 106 on the armature 105. When the coil 108 is de-energized, the first magnetic force resists the restoring tensile force, so that the armature 105 moves toward the grooved disc 104 and correspondingly engages with the grooved disc 104, so as to lock the rotating shaft of the brake motor. The coil 108 is disposed on the stator 101, the coil 108 generating a second magnetic force on the armature 105 after being energized, the second magnetic force being opposite in direction to the first magnetic force, and the resultant force of the second magnetic force and the restoring tensile force being greater than the first magnetic force. When the coil 108 is energized, the resultant force of the second magnetic force and the restoring tensile force resists the first magnetic force, so that the armature 105 moves toward the flange rotor 102 and disengages from the grooved disc 104, so as to release the rotating shaft of the brake motor.

Specifically, the stator 101 is a fixed iron core portion on the power-off brake 100. The main body of the stator is in the shape of a disc, a shaft extension portion extending out of a top surface (opposite a bottom surface) of the disc by a certain length is disposed at a center position of the disc, and the shaft extension portion may be in the shape of a circular tube with a tube wall having a certain thickness. The bottom surface of the stator 101 is fixedly connected to an outer surface of an end cover of a brake motor corresponding to the power-off brake 100. Illustratively, at least three connecting rings may be provided at intervals around the bottom of the stator 101, the connecting rings being connected to the end cover of the brake motor through bolts, so that the power-off brake 100 is fixed and integrated on the corresponding brake motor. A hollow portion of the stator 101 may allow the rotating shaft of the brake motor to pass through, so that the stator 101 is sleeved on the rotating shaft of the brake motor. The stator 101 may be a carrier of the grooved disc 104, the permanent magnet 107 and the coil 108, and may also provide a magnetic conduction path with low magnetic resistance to enhance the intensity and uniformity of a magnetic field. Illustratively, the stator 101 may be formed by laminating silicon steel sheets or another high-magnetic conduction material.

The flange rotor 102 is a rotating component on the power-off brake 100, and a flange portion of the flange rotor 102 may be provided with a plurality of groups of holes that are symmetrical about the center of the rotating shaft and penetrate both sides of the flange portion, used for mounting the elastic member 106 and the armature 105. Similar to the stator 101, the shaft extension portion of the flange rotor 102 is also in the shape of a circular tube with a tube wall having a certain thickness. An outer diameter of the circular tube is smaller than an inner diameter of the circular tube of the shaft extension portion on the stator 101, so that the shaft extension portion of the flange rotor 102 can be directly opposite to the shaft extension portion of the stator 101 and sleeved in the circular tube of the shaft extension portion of the stator 101. Then, the rolling bearing 103 is disposed between the outer wall of the circular tube of the shaft extension portion of the flange rotor 102 and the inner wall of the circular tube of the shaft extension portion of the stator 101. The flange rotor 102 and the stator 101 are connected through the rolling bearing 103 to realize a rolling connection between the flange rotor 102 and the stator. In addition, the inner wall of the circular tube of the shaft extension portion of the flange rotor 102 may be sleeved with the rotating shaft of the brake motor and connected to the rotating shaft by using a toothed spline, so that the flange rotor 102 can rotate relative to the stator 101 with the rotating shaft of the brake motor. Illustratively, the flange rotor 102 may also be formed by laminating silicon steel sheets or another high-magnetic permeability material, and the flange rotor 102 and the stator 101 may jointly provide a magnetic conduction path with low magnetic resistance to enhance the strength and uniformity of the magnetic field.

The grooved disc 104 is a hollow disc-shaped brake apparatus fixedly disposed on the stator 101, and a hollow through hole thereof may be sleeved around the shaft extension portion of the stator 101. A surface of the grooved disc 104 distant from the top surface of the stator 101 may be provided with grooves. The shape of these grooves may fit with the shape of protrusions on the surface of the armature 105 or the shape of the armature 105 itself. In one aspect, the configuration of the grooves can guide the armature 105 to be in more accurate and tight contact with the grooved disc 104. In another aspect, the configuration of the grooves can increase the contact area between the grooved disc 104 and the armature 105 when the armature 105 is engaged, so that the static friction force can be increased without increasing the overall size of the power-off brake 100, thereby improving a braking effect. In yet another aspect, the configuration of the grooves of the grooved disc 104 increases the contact area between the power-off brake 100 and the air, which can perform good heat dissipation for the power-off brake 100 and prolong the service life of the power-off brake 100. Illustratively, the grooved disc 104 may be made of a metal material having a certain rigidity and strength.

The armature 105 is a component made of a ferromagnetic material, and can be attracted or repelled by a magnetic force provided by a component on the stator 101. Illustratively, the armature 105 may include an integral hollow armature 105 disc adapted to the outer dimensions of the stator 101 and the flange rotor 102, or may include a plurality of armature 105 blocks arranged in a distributed manner. An elastic member 106 is further disposed between the armature 105 and the flange rotor 102. The armature 105 is fixed on a surface of the elastic member 106 distant from the flange stator 102 by a first rivet 110, and the other surface of the elastic member 106 is fixed on the flange stator 102 by a second rivet 111, thereby realizing a fixed connection among the flange rotor 102, the elastic member 106 and the armature 105. The elastic member 106 may be stretched or reset, thereby realizing reciprocating motion of the armature 105. When that the elastic member 106 is reset, an air gap of a preset length exists between corresponding positions of the armature 105 and the grooved disc 104. Illustratively, the elastic member 106 comprises a disc spring or a leaf spring. The elastic member 106 may be connected to the flange rotor 102 through several bolts, or may be connected to the armature 105 through another portion of bolts, all of the bolts needing to be centrally symmetrical with respect to the rotating shaft of the flange rotor 102.

The permanent magnet 107 may be disposed between the bottom surface of the grooved disc 104 and the top surface of the stator 101, and fixed to the stator 101 through a holder 112. Illustratively, the permanent magnet 107 may comprise an integral annular permanent magnet member sleeved on the outer side of the shaft extension portion of the stator 101; or the permanent magnet 107 also may comprise a plurality of tile-shaped or block-shaped permanent magnet members, the permanent magnet members being distributed and disposed around the shaft extension portion of the stator 101 in a centrally symmetrical manner. The permanent first magnetic force generated by the permanent magnet 107 on the armature 105 does not change with the state of other equipment such as the coil 108. The first magnetic force is greater than the restoring tensile force of the elastic member 106 acting on the armature 105. When the coil 108 is de-energized, the magnetic force of the coil 108 on the armature 105 disappears, and the first magnetic force is greater than the restoring tensile force of the elastic member 106 acting on the armature 105. Then, the armature 105 moves toward the grooved disc 104 and the elastic member 106 is stretched. With the movement of the armature 105, the air gap between the grooved disc 104 and the armature 105 decreases, and the first magnetic force increases until the length of the air gap is 0 and the first magnetic force reaches the maximum when the armature 105 is attracted by the grooved disc 104 to engage therewith. The permanent magnet 107 may be configured to apply the first magnetic force to the armature 105 to resist the restoring tensile force of the elastic member 106 on the armature 105 and keep the elastic member 106 in a stretched state when the coil 108 is de-energized, so that the engagement between the armature 105 and the grooved disc 104 is maintained, stably locking the rotating shaft of the brake motor, and improving the reliability of the brake.

The coil 108 may be disposed at the bottom of the grooved disc 104, encapsulated by an encapsulation layer, and fixed in place to the bottom of the grooved disc. Similar to the permanent magnet 107, the coil 108 may comprise an entire coil 108 wound around the shaft extension portion of the stator 101, or also may comprise a plurality of distributed small coils 108 distributed around the shaft extension portion of the stator 101 in a centrally symmetrical manner, which may be correspondingly disposed according to actual need. The coil 108 may be directly connected to a circuit board of a wheel end controller through two power pins 109 (which may also be referred to as Pins), thereby improving the response speed of a parking lock. After being energized, the coil 108 applies a second magnetic force to the armature 105, the second magnetic force being opposite in direction to the first magnetic force, that is, the second magnetic force being in the same direction as the restoring tensile force applied by the elastic member 106 to the armature 105. The magnitude of the second magnetic force may be proportional to the magnitude of the current in the coil 108, and is also related to the air gap between the grooved disc 104 and the armature 105. After the coil 108 is energized, the resultant force of the second magnetic force and the restoring tensile force on the armature 105 is greater than the first magnetic force, so that the armature 105 moves away from the grooved disc 104. At the moment when the air gap between the armature 105 and the grooved disc 104 changes from zero to non-zero, the current in the coil 108 decreases instantaneously, thereby causing the second magnetic force to also decrease. The reduced second magnetic force still ensures that the resultant force of the second magnetic force and the restoring tensile force on the armature 105 is greater than the first magnetic force, and the armature 105 continues to move away from the grooved disc 104 until the elastic member 106 is reset. While the coil 108 is energized, the armature 105 continuously remains in the disengaged state and the elastic member 106 remains in the reset state. At that time, the flange rotor 102 can rotate with the rotor of the brake motor, realizing release of the brake motor. In addition, the coil 108 may be disposed in a deep groove on the grooved disc 104 and fixed to the bottom of the deep groove by the encapsulation layer 112. The encapsulation layer 112 may be set to a thickness according to actual need. A corresponding groove is reserved on the surface of the grooved disc 104 to realize a corresponding fit with the armature. FIG. 1 is only a schematic diagram, in which there are some exaggerations, and the grooves and the air gap are omitted.

The power-off brake provided by the embodiment of the present invention is provided with a stator, a flange rotor, a rolling bearing, a grooved disc, an armature, an elastic member, a permanent magnet and a coil. A side of the stator distant from the flange rotor is connected to an end cover of the brake motor. The flange rotor is connected to the rotating shaft of the brake motor, and also connected to the stator through the rolling bearing, so that the flange rotor can rotate relative to the stator along with the rotating shaft of the brake motor. The grooved disc is disposed on a side of the stator close to the stator. The armature is disposed between the grooved disc and the flange rotor, and is connected to the flange rotor through the elastic member, so that the armature can reciprocate between the flange rotor and the grooved disc along an axial direction of the flange rotor, and a shape of a groove on the grooved disc fits with a shape of the armature directly facing the groove. The permanent magnet is disposed on the stator, the permanent magnet generating a first magnetic force on the armature, the first magnetic force being opposite in direction to a restoring tensile force of the elastic member on the armature, and the first magnetic force being greater than the restoring tensile force of the elastic member on the armature; when the coil is de-energized, the first magnetic force resists the restoring tensile force, so that the armature moves toward the grooved disc and correspondingly engages with the grooved disc, so as to lock the rotating shaft of the brake motor. The coil is disposed on the stator, the coil generating a second magnetic force on the armature after being energized, the second magnetic force being opposite in direction to the first magnetic force, and a resultant force of the second magnetic force and the restoring tensile force being greater than the first magnetic force; when the coil is energized, the resultant force of the second magnetic force and the restoring tensile force resists the first magnetic force, so that the armature moves toward the flange rotor and disengages from the grooved disc, so as to release the rotating shaft of the brake motor, thereby realizing locking and releasing of the corresponding brake motor. The brake is integrated on the motor, which reduces volume, noise and energy loss compared with the prior art, and the structure is simple, which lowers manufacturing and testing difficulty.

Optionally, on the basis of the foregoing embodiment, with continued reference to FIGS. 1 and 2, the power-off brake 100 further comprises a micro switch 200. The micro switch 200 is disposed on the stator 101 and may be disposed between the grooved disc 104 and the armature 105, so that the micro switch 200 is triggered to turn on when the armature 105 is engaged with the grooved disc 104, and returns to an off state when the armature 105 is disengaged from the grooved disc 104.

Specifically, the micro switch 200 is a switch having a minute stroke and rapid action, and its working principle is to cause the contact to be rapidly turned on or off by using an external mechanical force. When the externally applied force reaches a certain level, an elastic element (such as a spring blade) of the micro switch 200 is deformed, thereby changing the state of the contact.

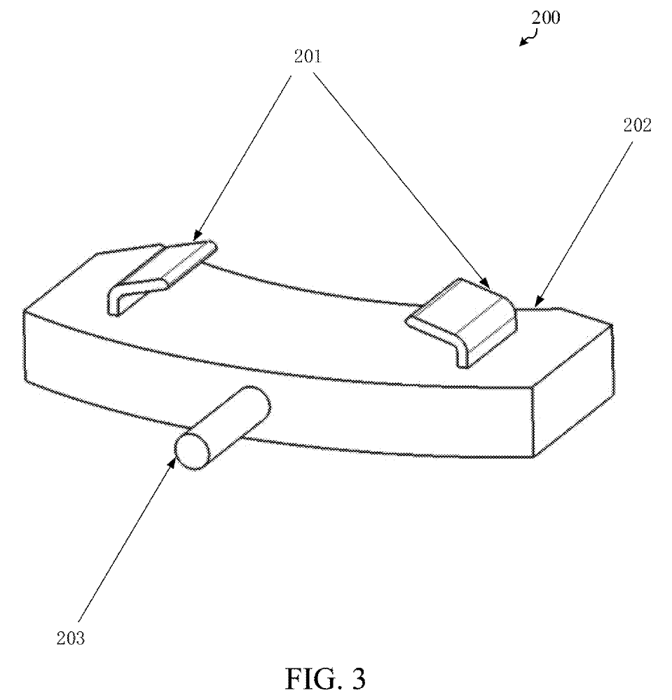

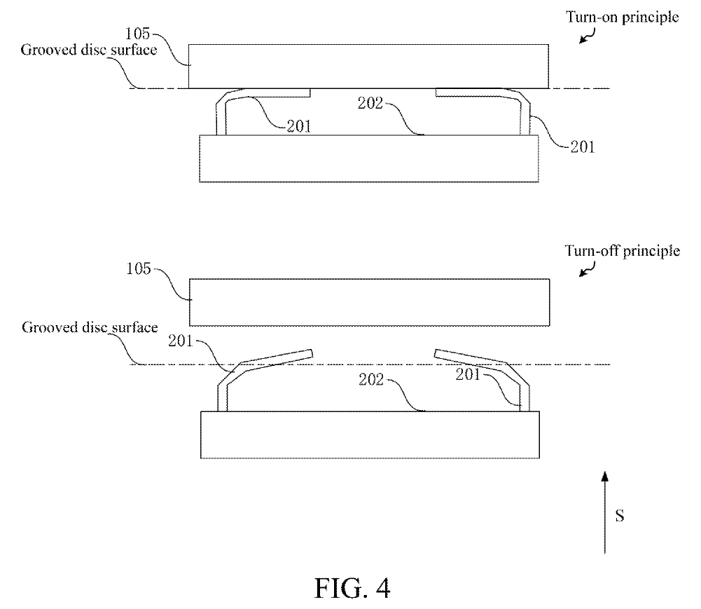

Illustratively, FIG. 3 is a schematic structural diagram of a micro switch provided by an embodiment of the present invention, and FIG. 4 is a schematic diagram showing the principle of a micro switch provided by an embodiment of the present invention when it is turned on and off. With reference to FIGS. 1, 3 and 4, the micro switch 200 comprises two micro spring blades 201, a state detection member 202 and an output terminal 203, wherein the micro spring blades 201 may be metal spring blades, roots of the two micro spring blades 201 and the output terminal 203 are separately connected to the state detection member 202, and ends of the micro spring blades 201 extend beyond a surface of the grooved disc 104 in contact with the armature 105 in a first direction S, so that the two micro spring blades 201 are disconnected when the armature 105 is disengaged from the grooved disc 104, and the two micro spring blades 201 are connected through the armature 105 when the armature 105 is engaged with the grooved disc 104. The first direction S refers to a direction from the stator 101 to the flange rotor 102 along a central axis of the flange rotor 102. The state detection member 202 is used to: generate and externally output a disengaged state signal through the output terminal 203 when the two micro spring blades 201 are disconnected, and generate and externally output an engaged state signal through the output terminal 203 when the two micro spring blades 201 are connected. Illustratively, the state signals may be fed back to a vehicle controller or a circuit board of a wheel end controller.

In the power-off brake provided by this embodiment, the micro switch is disposed on the stator, so that the micro switch is triggered to turn on when the armature is engaged with the grooved disc, and returns to an off state when the armature is disengaged from the grooved disc, thereby realizing mechanical detection of the operation state of the power-off brake, and improving the reliability of the electromechanical brake system.

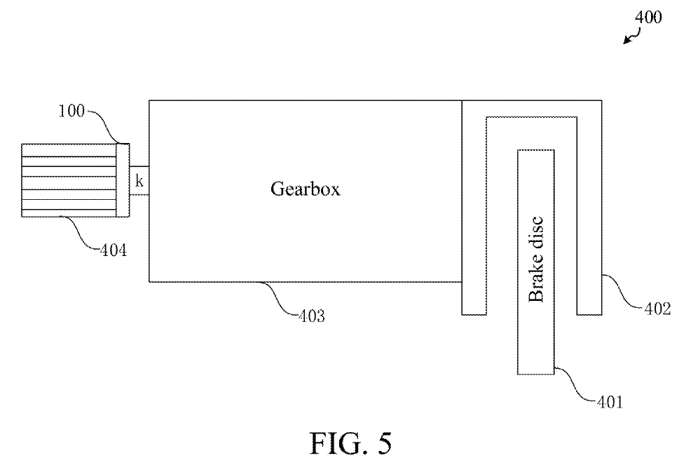

The embodiments of the present invention further provide an electromechanical brake system. FIG. 5 is a schematic diagram of the composition of an electromechanical brake system provided by an embodiment of the present invention. With reference to FIGS. 1 and 5, the electromechanical brake system 400 comprises a brake disc 401, a brake caliper 402, a gearbox 403, a brake motor 404, and the power-off brake 100 according to any one of the embodiments of the present invention, wherein the power-off brake 100 and the brake motor 404 are integrated into a motor assembly.

Specifically, the brake disc 401 is a circular metal disc that may be mounted near a hub of a wheel and rotate together with the wheel. Illustratively, in some automobiles, the brake disc 401 may be located inside a wheel. The brake caliper 402 may include a caliper body, a piston, a brake pad and other parts, wherein the caliper body may be a clamp or a plier structure, a piston is disposed in the caliper body, and the piston is used to push the brake pad to move. The brake pad is generally made of a friction material, and illustratively, the material of the brake pad may be a semi-metal or a ceramic. When the brake caliper is in a braking state, the piston is driven by the gearbox to move in a piston cylinder, thereby driving the brake pad to clamp the brake disc, and the friction between the brake disc and the brake pad can slow down or stop the wheel.

In the electromechanical brake system 400, the gearbox 403 is provided between a rotating shaft k of the brake motor 404 and the brake caliper 402, and mainly provides the function of transmitting power and changing a rotation speed and a torque. The gearbox 403 may be provided with a shaft, a central wheel, a planetary wheel and a ring gear, and these mechanical components cooperate with each other to convert a high-speed small torque output by the brake motor 404 into a low-speed and large torque suitable for the operation of the electromechanical brake system 400, and the low-speed and large torque is ultimately output by the brake caliper 402.

The brake motor 404 is a power source of the electromechanical brake system 400, and provides required power for subsequent movement of the gearbox 403 and the brake caliper 402 according to a control signal. The power-off brake 100 is disposed on an end cover of the brake motor 404, the stator 101 is fixedly connected to the end cover, and an inner ring of the flange rotor 102 is fixedly connected to the rotating shaft of the brake motor, so that the power-off brake 100 and the brake motor are integrated into a motor assembly, which is small in volume and regular in shape compared with a ratchet-pawl structure disposed in a gearbox, thereby reducing the difficulty and cost of manufacturing and mounting the brake system. After the brake motor 404 completes a braking action, the power-off brake 100 may lock the brake motor according to the control signal, so as to lock the electromechanical brake system 400, thereby maintaining continuous clamping of the brake caliper 402 on the brake disc 401, providing the function of assisting parking, and improving the parking reliability of the automobile.

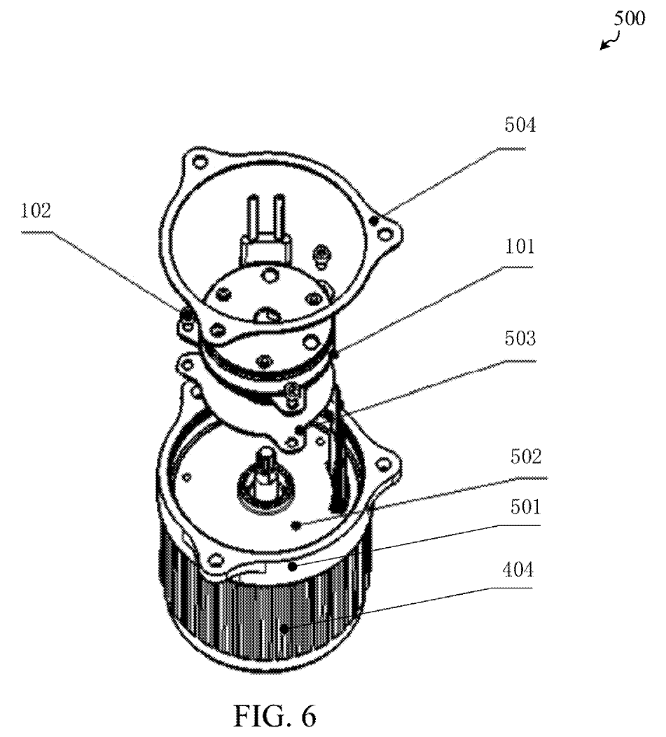

Optionally, FIG. 6 is a schematic diagram of the composition of a motor assembly provided by an embodiment of the present invention, in which each component of the motor assembly is illustratively shown in a three-dimensional assembly manner. On the basis of any of the foregoing embodiments, with reference to FIGS. 1 and 6, the motor assembly 500 in the electromechanical brake system 400 further comprises a protective ring 501. One end of the protective ring 501 is sleeved on a side surface of the end cover 502 of the brake motor 404, and forms an annular groove with an outer surface of the end cover 502 and the rotating shaft of the brake motor 404. The power-off brake 100 is disposed in the annular groove, the stator 101 of the power-off brake 100 is connected to a screw groove on the end cover 502 through a bolt, and the flange rotor 102 of the power-off brake 100 is connected to the rotating shaft through a toothed spline. In other embodiments, the protective ring 501 may be integrally formed with the end cover 502 of the motor, and this element can directly form an annular groove with the rotating shaft of the brake motor 404 for placing and mounting the power-off brake 100, which is not limited herein.

The motor assembly 500 further includes a first thermal insulation damping washer 503 and a second thermal insulation damping washer 504. The first thermal insulation damping washer 503 is disposed between the stator 101 and the end cover 502, and is used to reduce heat propagation and vibration propagation between the stator 101 and the end cover 502. The second thermal insulation damping washer 504 is disposed between an end face of the protective ring 501 and the gearbox, and is used to reduce heat propagation and vibration propagation between the power-off brake 100 and the gearbox.

According to the electromechanical brake system provided by the embodiment of the present invention, the brake motor and the power-off brake are integrated into a motor assembly. The motor assembly further includes a protective ring. The protective ring is sleeved and mounted on a side surface of an end cover of the brake motor, and may form an annular groove with an outer surface of the end cover and a rotating shaft of the brake motor, allowing the power-off brake to be placed and mounted therein, thereby improving a degree of integration between the brake motor and the power-off brake, greatly simplifying the composition and structure of the electromechanical brake system and reducing the volume occupied by the brake system compared with the manner of implementing auxiliary parking by using a ratchet and a pawl in the prior art. In addition, the electronic brake system is further provided with a first thermal insulation damping washer and a second thermal insulation damping washer, so as to reduce heat propagation and vibration propagation between the stator and the end cover and between the power-off brake and the gearbox, thereby greatly improving the reliability of the brake system and prolonging the service life of the brake system.

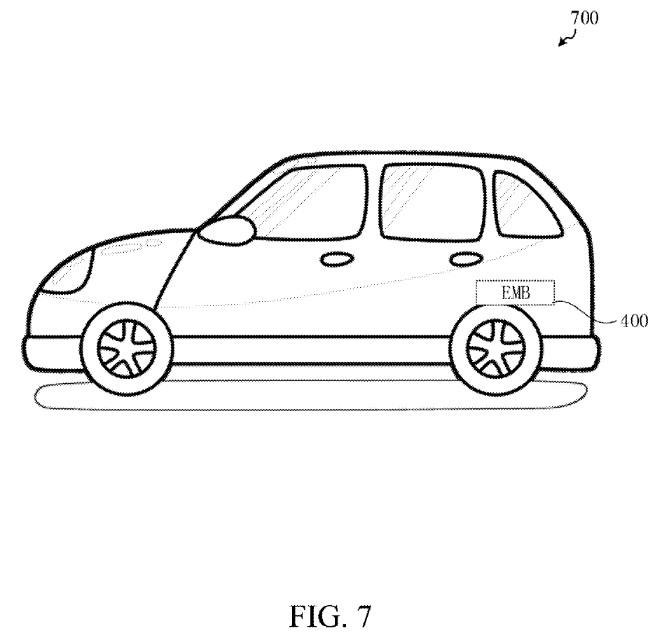

The present invention further provides an automobile. FIG. 7 is a schematic diagram of the composition of an automobile provided by an embodiment of the present invention. With reference to FIG. 7, the automobile 700 includes the electromechanical brake system 400 according to any one of the foregoing embodiments. The electromechanical brake system 400 having the power-off brake is applied to the automobile 700, so that the noise of assisted parking of the automobile can be reduced, and the speed and reliability of assisted parking of the automobile can be improved.

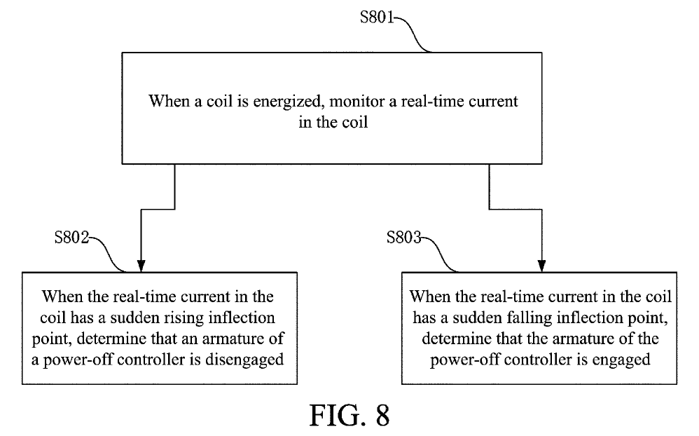

The present invention further provides a state monitoring method for a power-off controller, which may be implemented by a control apparatus corresponding to an electromechanical brake system. Illustratively, the control apparatus may be a circuit board of a wheel end controller. FIG. 8 is a schematic flowchart of a state monitoring method for a power-off brake provided by an embodiment of the present invention. On the basis of any one of the foregoing embodiments, with reference to FIG. 8, the state monitoring method for the power-off controller comprises:

S801: When a coil is energized, monitor a real-time current in the coil.

Specifically, since the electromagnetic force provided by the coil to the armature in the power-off brake is strongly correlated with the coil current and is controlled by the current loop, the state of the power-off brake can be determined by monitoring the real-time current in the coil. Illustratively, the real-time current in the coil may be monitored by using a current transformer disposed on a power input line of the coil.

S802: When the real-time current in the coil has a sudden rising inflection point, determine that the armature of the power-off controller is disengaged.

Specifically, the sudden rising inflection point refers to a time node at which the current in the coil will increase and change by more than a preset increment within a unit time thereafter, and the sudden rising inflection point may be determined according to monitoring data of the real-time current in the coil. Illustratively, the real-time current in the coil is sampled (or monitored) by using a sampling window of 2 microseconds. During the sampling process, a difference between an end current value and an initial current value in the sampling window is calculated. When the difference is greater than the preset increment, it can be determined that the real-time current has a sudden rising inflection point, and that the armature of the power-off controller is disengaged.

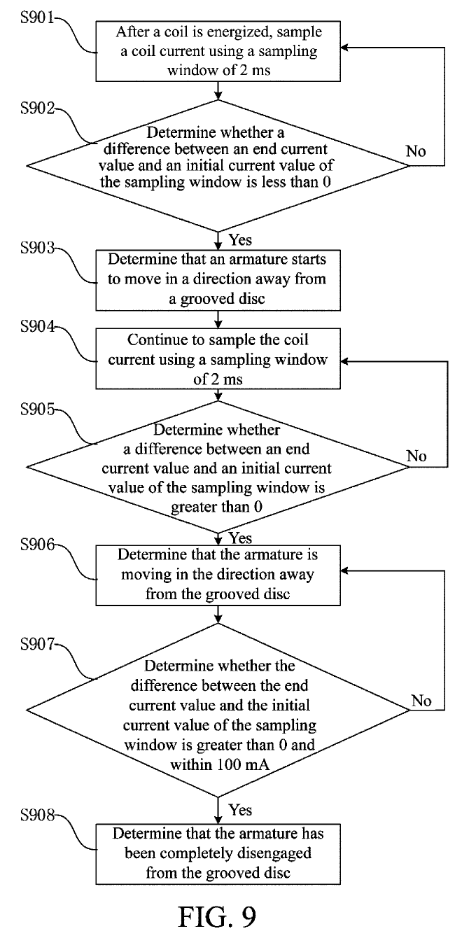

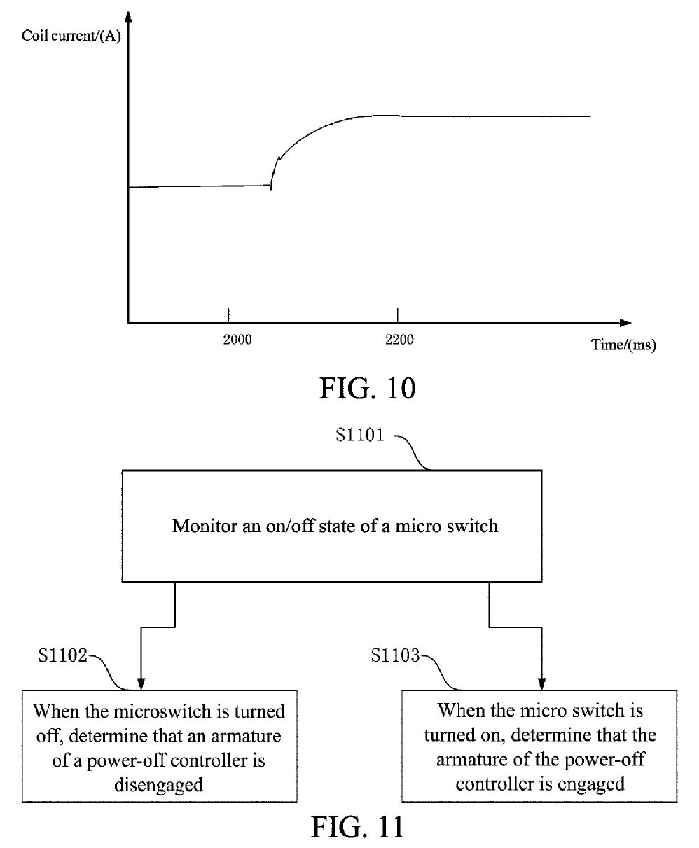

Illustratively, FIG. 9 is a schematic flowchart of a stepwise determination method for an armature disengagement process provided by an embodiment of the present invention, and FIG. 10 is a curve of changes of a coil voltage and a coil current before and after armature disengagement of a power-off controller provided by an embodiment of the present invention. On the basis of any one of the foregoing embodiments, with reference to FIGS. 9 and 10, if it is necessary to perform specific stepwise determination and analysis on the armature disengagement process, the following method may be used: S901: After the coil is energized, sample a coil current by using a sampling window of 2 ms. S902: Determine whether a difference between an end current value and an initial current value of the sampling window is less than 0. S903: If so, determine that the armature starts to move in a direction away from the grooved disc. At this time, the armature has not yet disengaged from the grooved disc. For example, the interaction force between the armature and the grooved disc is reduced and some deformation of the contact surface between the two occurs. S904: After it is determined that the armature starts to move in the direction away from the grooved disc, continue to sample the coil current using a sampling window of 2 ms. S905: Determine whether a difference between an end current value and an initial current value of the sampling window is greater than 0. S906: If so, determine that the armature is moving in the direction away from the grooved disc. At this time, the armature is no longer in full contact with the grooved disc and the movement away from the grooved disc is still in progress. S907: Determine whether the difference between the end current value and the initial current value of the sampling window is greater than 0 and within 100 mA. S908: If so, determine that the armature has been completely disengaged from the grooved disc.

S803: When the real-time current in the coil has a sudden falling inflection point, determine that the armature of the power-off controller is engaged.

Specifically, the sudden falling inflection point refers to a time node at which the current in the coil will decrease and change by more than a preset decrement within a unit time thereafter, and the sudden falling/rising inflection point may be determined according to monitoring data of the real-time current in the coil. Illustratively, the real-time current in the coil is sampled (or monitored) by using a sampling window of 2 microseconds. During the sampling process, a difference between an initial current value and an end current value in the sampling window is calculated. When the difference is less than the preset decrement, it can be determined that the real-time current has a sudden falling inflection point, and that the armature of the power-off controller is engaged.

In the state monitoring method for the power-off controller provided by this embodiment, the real-time current in the coil is monitored when the coil is energized. When the real-time current in the coil has a sudden rising inflection point, it is determined that the armature of the power-off controller is disengaged. When the real-time current in the coil has a sudden falling inflection point, it is determined that the armature of the power-off controller is engaged. The state of the power-off controller is monitored by means of current monitoring, the engagement and disengagement state of the armature is accurately determined, and feedback is provided to the wheel end or the vehicle end, thereby improving the visibility of the auxiliary parking function and improving the user experience.

Optionally, FIG. 11 is a schematic flowchart of another state monitoring method for a power-off brake provided by an embodiment of the present invention. On the basis of any one of the foregoing embodiments, with reference to FIGS. 8 and 11, the state monitoring method for the power-off controller may further comprise:

S1101: Monitor an on/off state of a micro switch.

S1102: When the micro switch is turned off, determine that the armature of the power-off controller is disengaged.

S1103: When the micro switch is turned on, determine that the armature of the power-off controller is engaged.

In the state monitoring method for the power-off controller provided by this embodiment, when the coil is energized, the real-time current in the coil is monitored. When the real-time current in the coil has a sudden rising inflection point, it is determined that the armature of the power-off controller is disengaged. When the real-time current in the coil has a sudden falling inflection point, it is determined that the armature of the power-off controller is engaged. The on/off state of the micro switch is also monitored while the coil current is monitored. When the micro switch is turned off, it is determined that the armature of the power-off controller is disengaged. When the micro switch is turned on, it is determined that the armature of the power-off controller is engaged. By using the two methods of coil current monitoring and micro switch state monitoring, software determination and hardware determination of the state of the power-off brake are performed separately. The two methods can be implemented simultaneously to provide mutual redundancy, greatly improving the reliability of the electromechanical brake system.

It should be understood that steps may be reordered, added, or deleted using the various forms of processes shown above. For example, the steps described in the present invention may be performed in parallel, sequentially, or in a different order, as long as the desired results of the technical solutions of the present invention can be achieved, which is not limited herein.

The above detailed description of the embodiments does not constitute a limitation on the scope of protection of the present invention. It should be understood by those skilled in the art that various modifications, combinations, sub-combinations and substitutions may be made according to design requirements and other factors. Any modifications, equivalent replacements and improvements, etc. made within the spirit and principle of the present invention shall be included in the scope of protection of the present invention.

1. A power-off brake system comprising:
a brake motor shaft;
a stator coaxially disposed around the brake motor shaft;
a flange rotor connected to the brake motor shaft and to the stator via a rolling bearing, such that a flange rotor rotates with the brake motor shaft relative to the stator;
an armature connected to the flange rotor; and
a coil that: (i) in a de-energized state, causes the armature to engage a grooved disc, locking the brake motor shaft; and (ii) in an energized state, causes the armature to disengage the grooved disc, releasing the brake motor shaft.

2. The power-off brake system of claim 1, further comprising a micro switch disposed on the stator.

3. The power-off brake system of claim 2, wherein the micro switch is in an on state in response to the armature being engaged with the grooved disc.

4. The power-off brake system of claim 2, wherein the micro switch is in an off state in response to the armature being disengaged from the grooved disc.

5. The power-off brake system of claim 2, wherein the micro switch includes two micro spring blades, a state detection member, and an output terminal.

6. The power-off brake system of claim 5, wherein first portions of the two micro spring blades and the output terminal are separately connected to the state detection member.

7. The power-off brake system of claim 6, wherein end portions of the micro spring blades extend beyond the grooved disc in a first direction, such that the two micro spring blades are disconnected in response to the armature being disengaged from the grooved disc.

8. The power-off brake system of claim 6, wherein the two micro spring blades are connected through the armature in response to the armature being engaged with the grooved disc.

9. The power-off brake system of claim 5, wherein the state detection member: generates a disengaged state signal in response to the two micro spring blades being disconnected; and outputs the disengaged state signal via the output terminal.

10. The power-off brake system of claim 5, wherein the state detection member: generates an engaged state signal in response to the two micro spring blade being connected; and outputs the engaged state signal via the output terminal.

11. The power-off brake system of claim 1, further comprising an elastic member that includes a disc spring or a leaf spring.

12. An electromechanical brake system comprising:
a brake disc;
a brake caliper;
a gearbox;
a brake motor; and
a motor assembly comprising a power-off brake that includes:
a stator and a flange rotor coaxially stacked and sleeved around a rotating shaft of the brake motor;
a rolling bearing;
a grooved disc;
an armature;
an elastic member;
a permanent magnet; and
a coil, wherein:
a side of the stator distant from the flange rotor is connected to an end cover of the brake motor; the flange rotor is connected to the rotating shaft of the brake motor and also connected to the stator through the rolling bearing, so that the flange rotor can rotate relative to the stator along with the rotating shaft of the brake motor;
the grooved disc is disposed on a side of the stator close to the flange rotor; the armature is disposed between the grooved disc and the flange rotor, and is connected to the flange rotor through the elastic member, so that the armature can reciprocate between the flange rotor and the grooved disc along an axial direction of the flange rotor, and a shape of a groove on the grooved disc fits with a shape of the armature directly facing the groove;
the permanent magnet is disposed on the stator, the permanent magnet generating a first magnetic force on the armature, the first magnetic force being opposite in direction to a restoring tensile force of the elastic member on the armature, and the first magnetic force being greater than the restoring tensile force of the elastic member on the armature; when the coil is de-energized, the first magnetic force resists the restoring tensile force, so that the armature moves toward the grooved disc and correspondingly engages with the grooved disc, so as to lock the rotating shaft of the brake motor; and
the coil is disposed on the stator, the coil generating a second magnetic force on the armature after being energized, the second magnetic force being opposite in direction to the first magnetic force, and a resultant force of the second magnetic force and the restoring tensile force being greater than the first magnetic force, wherein when the coil is energized, the resultant force of the second magnetic force and the restoring tensile force resists the first magnetic force, so that the armature moves toward the flange rotor and disengages from the grooved disc, so as to release the rotating shaft of the brake motor.

13. The electromechanical brake system of claim 12, wherein the motor assembly further comprises a protective ring;
one end of the protective ring is sleeved and mounted on a side surface of an end cover of the brake motor, and forms an annular groove with an outer surface of the end cover and the rotating shaft of the brake motor; and
the power-off brake is disposed in the annular groove, the stator of the power-off brake is connected to the end cover through a bolt, and the flange rotor of the power-off brake is connected to the rotating shaft through a toothed spline.

14. The electromechanical brake system of claim 13, wherein the motor assembly further comprises a first thermal insulation damping washer and a second thermal insulation damping washer;
the first thermal insulation damping washer is disposed between the stator and the end cover, and is used to reduce heat propagation and vibration propagation between the stator and the end cover; and
the second thermal insulation damping washer is disposed between an end face of the protective ring and the gearbox, and is used to reduce heat propagation and vibration propagation between the power-off brake and the gearbox.

15. The electromechanical brake system of claim 13, wherein the electromechanical brake system is associated with a vehicle.

16. A state monitoring method for a power-off controller, the method comprising:
in response to a coil being energized, monitoring a real-time current in the coil;
determining, in response to the real-time current in the coil having a sudden rising inflection point, that an armature of the power-off controller is disengaged; and
determining, in response to the real-time current in the coil having a sudden falling inflection point, that the armature of the power-off controller is engaged.

17. The state monitoring method of claim 16, further comprising, in response to monitoring the real-time current in the coil, monitoring a state of a micro switch.

18. The state monitoring method of claim 17, further comprising determining, in response to the state of the micro switch indicating that the micro switch is turned off, that the armature of the power-off controller is disengaged.

19. The state monitoring method of claim 17, further comprising determining, in response to the state of the micro switch indicating that the micro switch is turned on, that the armature of the power-off controller is engaged.

20. The state monitoring method of claim 16, wherein the coil is associated with a power-off brake.
